(19) United States
(12) Patent Application Publication
(10) Pub. No.: US 2024/0378414 A1
(43) Pub. Date: Nov. 14, 2024

(54) EMBEDDING COMPRESSION FOR EFFICIENT REPRESENTATION LEARNING IN GRAPH

(71) Applicant: Visa International Service Association, San Francisco, CA (US)

(72) Inventors: Michael Yeh, Newark, CA (US); Yan Zheng, Los Gatos, CA (US); Huiyuan Chen, San Jose, CA (US); Zhongfang Zhuang, San Jose, CA (US); Junpeng Wang, Santa Clara, CA (US); Liang Wang, San Jose, CA (US); Wei Zhang, Fremont, CA (US); Mengting Gu, Stanford, CA (US); Javid Ebrahimi, San Francisco, CA (US)

(73) Assignee: Visa International Service Association, San Francisco, CA (US)

(21) Appl. No.: 18/692,625

(22) PCT Filed: Sep. 20, 2022
(86) PCT No.: PCT/US2022/044144

§ 371 Date: Mar. 15, 2024

Related U.S. Application Data
(60) Provisional application No. 63/249,852, filed on Sep. 29, 2021.

(51) Int. Cl. G06N 3/042

(52) U.S. Cl. CPC G06N 3/042

(57) ABSTRACT

A method performed by a server computer is disclosed. The method comprises generating a binary compositional code matrix from an input matrix. The binary compositional code matrix is then converted into an integer code matrix. Each row of the integer code matrix is input into a decoder, including plurality of codebooks, to output a summed vector for each row. The method then includes inputting a derivative of each summed vector into a downstream machine learning model to output a prediction.

### CROSS-REFERENCES TO RELATED APPLICATIONS

This application is a PCT application, which claims priority to and the benefit of U.S. Provisional Patent Application No. 63/249,852, filed on Sep. 29, 2021 which is herein incorporated by reference in its entirety.

### BACKGROUND

Graph neural networks (GNNs) are deep learning models that are designed specifically for graph data. GNNs typically rely on node features as the input node representation to the first layer. When applying GNNs on graphs without node features, it is possible to extract simple graph based node features (e.g., the number of degrees) or learn the input node representation (e.g., the embeddings) when training the network. Using GNNs to train input node embeddings for downstream models often leads to better performance, but the number of parameters associated with the embeddings grows linearly with the number of nodes. It is impractical to train the input node embeddings for large-scale graph data with a GNN in the memory of a graphics processing unit (GPU) as the memory cost for the embeddings alone can reach 238 gigabytes. An efficient node embedding compression method such that the GNN can be used in a GPU is desired.

Embodiments of the disclosure address this problem and other problems individually and collectively.

### SUMMARY

One embodiment of the invention includes a method. The method comprises: generating, by a server computer, a binary compositional code matrix from an input matrix derived from input data used to make a prediction; converting, by the server computer, the binary compositional code matrix into an integer code matrix; inputting, by the server computer, each row of the integer code matrix into a decoder comprising plurality of codebooks to output a summed vector for each row; inputting, by the server computer, derivatives of the summed vectors into a downstream machine learning model to output a prediction.

In some embodiments, the derivatives of the rows can be embeddings corresponding to the summed vectors of the rows, where the embeddings were produced by a multilayer perceptron. In some embodiments, the summed vector for each row can be an aggregated to form intermediate matrix. The rows of the intermediate matrix can be processed by the multilayer perceptron to produce a processed intermediate matrix, which may be an embedding matrix. The rows of the processed intermediate matrix can be input into the downstream learning model to output the prediction.

Another embodiment of the invention includes a computer comprising a processor and a non-transitory computer readable medium comprising instructions, executable by the processor, to perform operations including: generating, by a server computer, a binary compositional code matrix from an input matrix derived from input data used to make a prediction; converting, by the server computer, the binary compositional code matrix into an integer code matrix; inputting, by the server computer, each row of the integer code matrix into a decoder comprising plurality of codebooks to output a summed vector for each row; inputting, by the server computer, derivatives of the summed vectors into a downstream machine learning model to output a prediction.

A better understanding of the nature and advantages of embodiments of the invention may be gained with reference to the following detailed description and accompanying drawings.

### BRIEF DESCRIPTION OF THE DRAWINGS

FIG. 1 shows a system according to embodiments.

FIG. 2 shows an encoding algorithm according to embodiments.

FIG. 3 shows four histograms generated using metapath2vec embeddings according to embodiments.

FIG. 4 shows four histograms generated using GloVe embeddings according to embodiments.

FIG. 5 shows a data flow diagram illustrating use of a decoder according to embodiments.

FIG. 6 shows a flow diagram that can integrate a GraphSAGE model according to embodiments.

FIG. 7 shows four graphs of a performance metric vs number of compressed entities according to embodiments.

FIG. 8 shows a table comparing performances of a baseline method, random coding method, and the method of embodiments.

FIG. 9 illustrates an exemplary dot product calculation process.

FIG. 10 illustrates an exemplary binarizing process.

### DETAILED DESCRIPTION

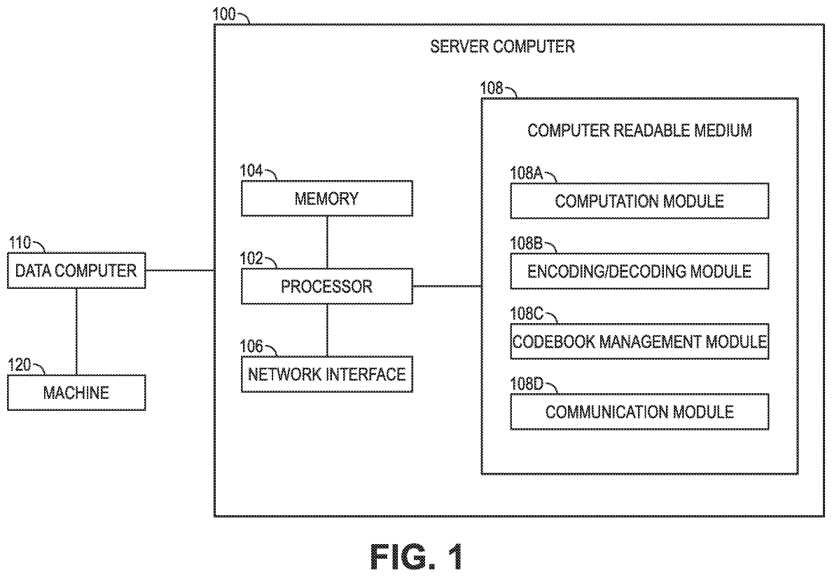

FIG. 1 shows a system according to embodiments. The system comprises a server computer 100, a data computer 110, and a machine 120. The server computer 100 comprises a processor 102, which may be coupled to a memory 104, a network interface 106, and a non-transitory computer readable medium 108.

The data computer 110 may be operated by a data aggregator, such as a processing network, web host, bank, traffic monitor, etc. The data computer 110 can aggregate data, such as traffic data (e.g., network traffic, car traffic), interaction data (e.g., transaction data, access request data), word or speech data, or some other data that can be represented by a graph. For example, traffic data can be represented on a two-dimensional graph by location (e.g., for car traffic, each car can be put on a map), or by a combination of a location (e.g., for website traffic, the website requestor's IP address and the website server IP address). In some embodiments, the data computer 110 may compile data, and transmit the data to the server computer 100. The data computer 110 may request the server computer 100 to analyze the data and generate a prediction using the compiled data. The data computer 110 may then receive the prediction, and instruct the machine 120 accordingly. For example, the data computer 110 can monitor car traffic and transmit traffic data to the server computer 100. The data computer 110 can request for the server computer 100 to analyze traffic patterns in the traffic data using some downstream model (e.g., a neural network). The server computer 100 may analyze the traffic data and generate a prediction, such as predicting a level of traffic during a specific time period. The server computer 100 can then transmit the prediction to the data computer 110, which may then instruct the machine 120 to actuate, such as instructing a traffic light controller to change lights, to improve traffic flow.

The components in the system of FIG. 1 and any of the following figures can be in operative communication with each other through any suitable communications medium. Suitable examples of the communications medium may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices of FIG. 1 may be transmitted using a secure communications protocol such as, but not limited to, File Transfer Protocol (FTP); HyperText Transfer Protocol (HTTP); and Secure Hypertext Transfer Protocol (HTTPS).

The memory 104 may be coupled to the processor 102 internally or externally (e.g., via cloud-based data storage), and may comprise any combination of volatile and/or non-volatile memory such as RAM, DRAM, ROM, flash, or any other suitable memory device.

The network interface 106 may include an interface that can allow the server computer 100 to communicate with external computers and/or devices. The network interface 106 may enable the server computer 100 to communicate data to and from another device such as the data computer 110. Some examples of the network interface 106 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 106 may include Wi-Fi. Data transferred via the network interface 106 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 106 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

The computer readable medium 108 may comprise code, executable by the processor 102, for a method comprising: generating, by a server computer, a binary compositional code matrix from an input matrix derived from input data used to make a prediction; converting, by the server computer, the binary compositional code matrix into an integer code matrix; inputting, by the server computer, each row of the integer code matrix into a decoder comprising plurality of codebooks to output a summed vector for each row; inputting, by the server computer, derivatives of the summed vectors into a downstream machine learning model to output a prediction.

The computer readable medium 108 may comprise a number of software modules including, but not limited to, a computation module 108A, an encoding/decoding module 108B, a codebook management module 108C, and a communication module 108D.

The computation module 108A may comprise code that causes the processor 102 to perform computations. For example, the computation module 108A can allow the processor 102 to perform addition, subtraction, multiplication, matrix multiplication, comparisons, etc. The computation module 108A may be accessed by other modules to assist in executing algorithms.

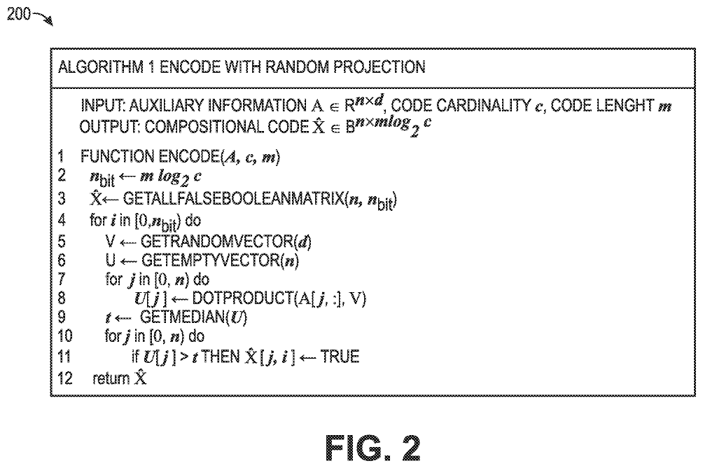

The encoding/decoding module 108B may comprise code that causes the processor 102 to encode and decode data. For example, the encoding/decoding module 108B can store encoding and decoding algorithms, such as the encoding algorithm 200 shown in FIG. 2. The encoding/decoding module 108B can access the computation module 108A to execute such algorithms.

The codebook management module 108C may comprise code that causes the processor 102 to manage codebooks. For example, the codebook management module 108C can store and modify codebooks generated by the encoding/decoding module 108B. A “codebook” can be a set of vectors that can be used to transform an integer code vector to an integer vector. Codebooks are further described in Zhang et al., Learning non-redundant codebooks for classifying complex objects, ICML '09: Proceedings of the 26th Annual International Conference on Machine Learning, June 2009 Pages 1241-1248; https://doi.org/10.1145/1553374.1553533.

The communication module 108D may comprise code that causes the processor 102 to generate messages, forward messages, reformat messages, and/or otherwise communicate with other entities.

Graph neural networks (GNNs) are representation learning methods for graph data. When a GNN is applied on a node classification problem, the GNN typically learns the node representation from input node features X and its graph G, where the input node features X are used as the input node representation to the first layer of the model and the graph G dictates the propagation of information. Examples of a GNN can be found in Zhou et al., “Graph Neural Networks: A Review of Methods and Applications,” AI Open, 1:57-81, 2020. However, the input node features X may not be available for every dataset. In order to apply a GNN to a graph without input node features X, it is possible to either 1) extract simple graph based node features (e.g., number of degrees) from the graph, or 2) use embedding learning methods to learn the node embeddings as input node features X such as in Duong et al., “On Node Features for Graph Neural Networks,” arXiv preprint arXiv:1911.08795, 2019. The second approach often outperforms the first, and many methods, such as in Wang et al., “Neural Graph Collaborative Filtering,” Proceedings of the 42^{nd} International ACM SIGIR Conference on Research and Development in Information Retrieval, pp. 165-174, 2019, learn the node embeddings jointly with the parameters of the GNN.

Learning the input node features X (or equivalently the embedding matrix X) for a graph with a small number of nodes can be performed without difficulty by a common computer system. However, as the size of the embedding matrix X grows linearly with the number of nodes, scalability becomes a prominent issue. For example, if a given graph has 1 billion nodes, the dimension of the learned embedding is set to 64, and the embedding matrix X is stored using a single-precision floating-point format, the memory cost for the embedding layer alone is 238 gigabytes which is beyond the capability of many common graphics processing units (GPUs).

To reduce the memory requirement, embodiments represent nodes using a generated binary compositional code vector, such as described for natural language processing in Takase, Sho and Kobayashi, Sosuke. “All Word Embeddings from One Embedding.” arXiv preprint arXiv:2004.12073, 2020. Then, a decoder model that can be trained end-to-end with a downstream model, uncompresses the binary compositional code vector into a floating-point vector. The bit size of the binary compositional code vector is parameterized by a code cardinality value c, and a code length value m. The code cardinality value c determines which values the elements of the code vector can take, and the code length value m determines how many elements the code vector has. For example, if the code cardinality c=4 and the code length m=6, one valid code vector is [2, 0, 3, 1, 0, 1], where each element of the code vector is within the set {0, 1, 2, 3} and the length of the code vector is 6. The code vector can be converted to a bit vector of length m log₂ c by representing each element in the code vector as a binary number, and concatenating the resulting binary numbers. Continuing the above example, the code vector [2, 0, 3, 1, 0, 1] can be compactly stored as [10, 00, 11, 01, 00, 01]. The choice of c=64 and m=8 can uniquely represent 2⁴⁸ nodes (e.g., the exponent determined by 8 log₂ 64=48).

Embodiments can use a random projection method to generate a code vector for each entity in a graph using auxiliary information of the graph, such as the adjacency matrix associated with the graph G of a pre-trained embedding. Random projection can process entities (nodes) with similar auxiliary information into similar code vectors. Such random projection methods are known as locality-sensitive methods, further details of which are described in Charikar, Moses, “Similarity Estimation Techniques from Rounding Algorithms,” Proceedings of the 34^{th} annual ACM Symposium on Theory of Computing, pp. 380-388, 2002.

FIG. 2 shows an encoding algorithm 200 according to embodiments. The encoding algorithm 200 is a random projection-based method used to generate a binary compositional code matrix \hat{X}, which is derived from graph data, which is in turn derived from input data. The encoding algorithm 200 may take as input a matrix A∈ [symbol] , where n is a number of nodes of an associated graph and d is the length of a first vector associated with each node. The encoding algorithm 200 can additionally take as input a code cardinality value c, and a code length value m. The code cardinality value c and the code length value m determine the format and associated memory cost of the output binary compositional code matrix \hat{X}. The output binary compositional code matrix \hat{X}, can be in a binary format, where each row of the binary compositional code matrix \hat{X} comprises a node's associated binary code vector.

In some embodiments, the input matrix A can comprise auxiliary information of a graph, such as the adjacency matrix of the graph. In other examples, the input matrix A can be generated by sampling a batch of nodes of a graph. For each node of the batch, a set of nearest neighbor nodes of the node can be sampled, retrieving the adjacency matrix. In yet other example, the input matrix A can further include a set of second nearest neighbors of the batch of nodes. For example, for each node of the batch, the set of nearest neighbor nodes of the node can be sampled, and for each node in the set of nearest neighbor nodes, a set of nearest neighbor nodes can be sampled (e.g., the second nearest neighbors of the original node of the batch of nodes). For a transaction graph, the input matrix A may comprise the relationships between bank accounts. For example, the graph may show bank accounts as nodes, and the input matrix A can be the adjacency matrix of the graph which contains information about the connections between the bank accounts (e.g., where each bank account moves funds to and receives funds from). If the input matrix A comprises an adjacency matrix, the number of nodes may be equal to the length of the first vector associated with each node (e.g., n=d).

In line 1 of the encoding algorithm 200, an input matrix A, code cardinality value c, and code length value m can be input into the algorithm. A user of the algorithm can obtain a code cardinality value c and a code length value m based on the desired encoding to be performed. For example, if the user wishes to encode a total of M nodes, the user can determine values for the code cardinality value c and a code length value m appropriately (e.g., 2^{m log}^{₂}^{c}>M).

In line 2 of the encoding algorithm 200, the number of bits required to store each code vector is computed and stored in the variable nbt. The variable n_{bit} can be computed as equaling m log₂ c.

In line 3 of the encoding algorithm 200, the binary compositional code matrix \hat{X} can be initialized as a false Boolean matrix of size n×n_{bit}. For example, the initial binary compositional code matrix \hat{X} can be an n×n_{bit} sized matrix with each element of the initial binary compositional code matrix \hat{X} set to logical false. The binary compositional code matrix \hat{X} may later store the resulting binary compositional code vectors.

From lines 4 through 11 of the encoding algorithm 200, the binary compositional code vectors are generated bit-by-bit in the outer loop, and node-by-node in the inner loops. The outer loop iterates through each column of the initial binary compositional code matrix \hat{X}. Generating compositional codes in this order is a memory efficient way to perform random projections, as only a size d random vector is stored in each iteration. If the inner loop (e.g., lines 7-8) is switched with the outer loop (e.g., lines 4-11), it would require an [symbol] matrix to store all the random vectors for random projection. Line 4 begins the outer loop, which is repeated a number of iterations equal to the required number of bits n_{bit}.

In line 5 of the encoding algorithm 200, a first vector V∈ [symbol] (e.g., a random vector in a real number space of size d) is generated randomly. For example, a random number generator can be used to randomly assign a value for each of the elements of the first vector V. The first vector V can be used for performing the random projection.

In line 6 of the encoding algorithm 200, a second vector U∈ [symbol] (e.g., an empty vector in a real-number space of size n) is initialized as an empty vector. For example, the second vector U can be a vector with a total of n empty elements. The second vector U can store the result of the random projection.

In line 7 of the encoding algorithm 200, a first inner loop can be repeated for a total of n iterations. The first inner loop can populate each element of the second vector U.

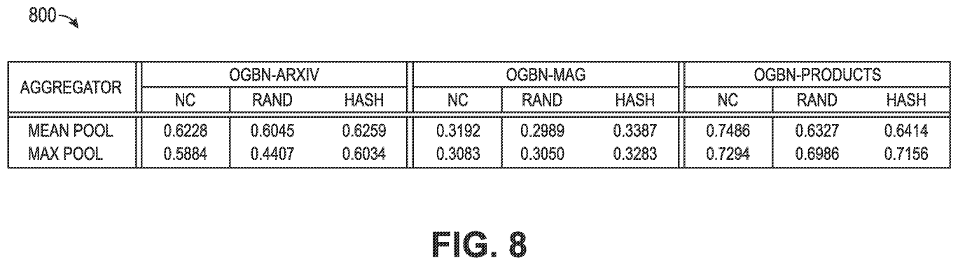

In line 8 of the encoding algorithm 200, each node's associated code vector is projected using the first vector V and stored in the second vector U. The jth element of the second vector U can be store the result of a dot product between the first vector V and the jth row of the input matrix A. For example, FIG. 9 provides an illustration of the dot product being performed to compute the a element of the second vector U. The a element of the second vector U is computed by computing the dot product between the first row of A and the first vector V (e.g., a=DotProduct(A[1, :], V)=2*2+1*0+1*0+0*1=2). Line 7 iterates the process for each element of the second vector U, such that each element of the second vector U stores the product between the first vector V and the jth row of the input matrix A. In some embodiments, only a few rows of the input matrix A are loaded into memory during the loop, instead of the entire input matrix A before the loop, to reduce the memory cost. This optimization can be implemented by a user when the size of the input matrix A is large for a computer system with limited memory.

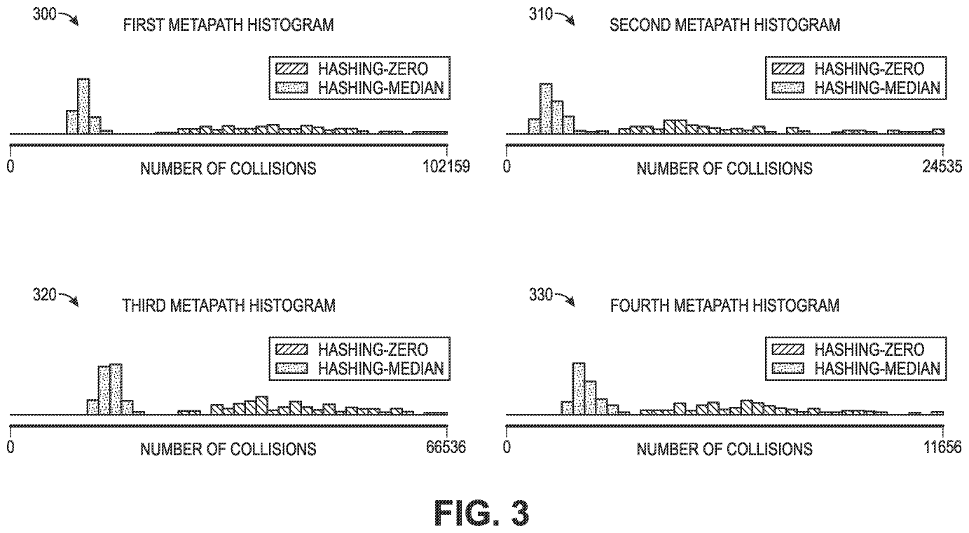

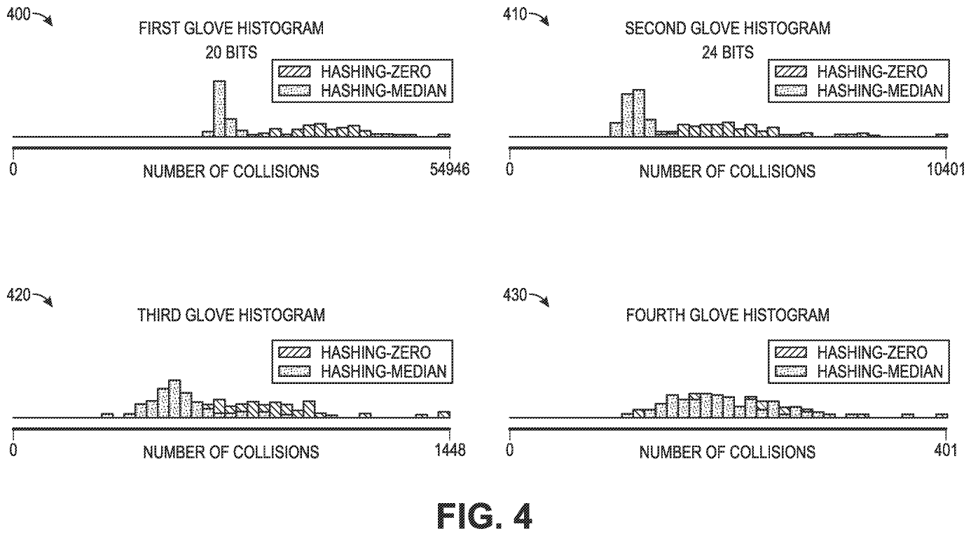

In line 9 of the encoding algorithm 200, a threshold value t is computed using the second vector U. The threshold value t can be used to binarize the real values of the second vector U. In some embodiments, the threshold value t can be computed by computing the median of the second vector U. The median can be used as the threshold value t to reduce the number of collisions (e.g., duplicates rows in the binary compositional code matrix \hat{X}), as shown in Dong et al., “Scalable Representation Learning for Heterogeneous Networks,” Proceedings of the 23^{rd} ACM SIGKDD International Conference on Knowledge Discovery and Data Mining, pp. 135-144, 2017a. A unique code vector for each input node is desired, and the choice of the threshold value t has a significant impact on the appearance rate of collisions. The impact of the choice of the threshold value t is summarized by the histograms of FIGS. 3 and 4.

In line 10 of the encoding algorithm 200, a second inner loop can be repeated for a total of n iterations. The second inner loop can binarize each element of the second vector U and store the binary result in the corresponding element of the initial binary compositional code matrix \hat{X}.

In line 11 of the encoding algorithm 200, the jth element of the second vector U is compared to the threshold value t. If the jth element of the second vector U is larger than the threshold value t, then the corresponding element of the initial binary compositional code matrix \hat{X} is set to logical true (e.g., \hat{X}[j,i]=True). The corresponding element of the initial binary compositional code matrix \hat{X} is determined by the value of i of the outer loop and the value of j of the second inner loop. Line 10 iterates through each element of the second vector U, such that they are all compared to the threshold value t.

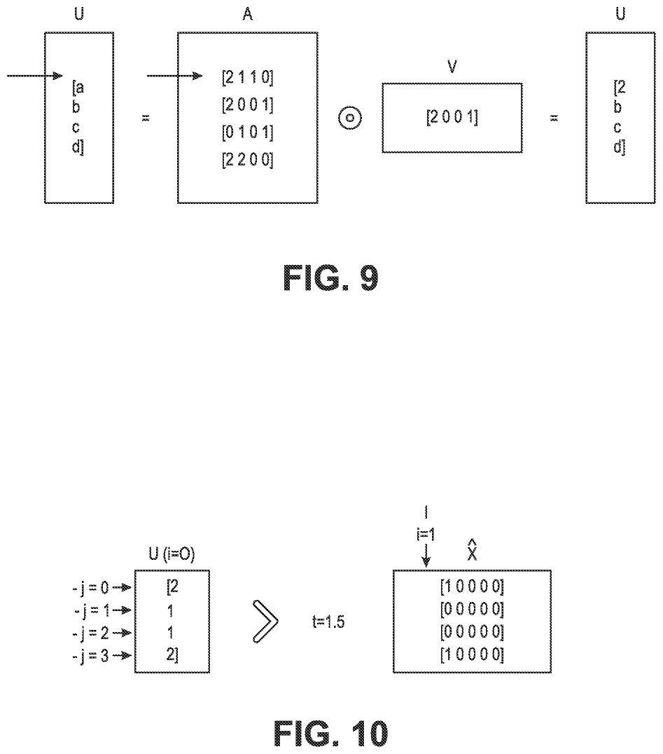

An illustration of the process of lines 10-11 is provided by FIG. 10. In the i=0 iteration of the outer loop, the second vector U can be [2, 1, 1, 2]. The threshold value t can be the median of the second vector U, which has a value of t=1.5. Each element of the second vector U can then be compared to the threshold value U. For the U(j=0) element, the comparison performed is 2>1.5, which has a result of True, or equivalently 1. Because the value is equal to True, the corresponding [j,i] element in the binary compositional code matrix \hat{X} can be set to equal True (e.g., \hat{X}[j=0, i=0]=1). A similar comparison can be performed for the U(j=1), U(j=2), and U(j=3) elements, and the corresponding element in the binary compositional code matrix \hat{X} to the result of the comparison (e.g., in this example, it would results in (False, False, True) or equivalently (0, 0, 1)). As is shown in FIG. 10, the second vector U of the first outer loop iteration (i=0) can be used to populate the first column of the binary compositional code matrix \hat{X}. Other iterations of the outer loop can populate subsequent columns of the binary compositional code matrix \hat{X}.

In line 12 of the encoding algorithm 200, the binary compositional code matrix \hat{X} can be returned. The binary compositional code matrix \hat{X} may then be used for any downstream tasks.

The memory complexity of the encoding algorithm 200 is O(MAX(nm log₂ c, df, nf)), where f is the number of bits used to store a floating-point number, nm log₂ c is the memory cost for storing the binary compositional code matrix \hat{X}, df is the memory cost associated with storing the first vector V, and nf is the memory cost associated with storing the second vector U. Typically, because f is usually less than m log₂ c and d≤n, the memory complexity of the encoding algorithm 200 is O(nm log₂ c), which is the same as the output binary compositional code matrix \hat{X}.

FIG. 3 shows four histograms generated using metapath2vec embeddings according to embodiments. Each histogram shows the relative number of collisions (e.g., duplicate rows in the binary compositional code matrix \hat{X}) that are encountered when running the encoding algorithm one hundred times on a set of metapath2vec and metapath2vec++ embeddings. The metapath2vec embeddings can be found in the aforementioned Dong et al., ““Scalable Representation Learning for Heterogenous Networks.” A first metapath histogram 300 is formed by running the encoding algorithm 200 one hundred times with a code length of n_{bit}=24 on metapath2vec embeddings. A second metapath histogram 310 is formed by running the encoding algorithm 200 one hundred times with a code length of n_{bit}=32 on metapath2vec embeddings. A third metapath histogram 320 is formed by running the encoding algorithm 200 one hundred times with a code length of n_{bit}=24 on metapath2vec++ embeddings. A fourth metapath histogram 330 is formed by running the encoding algorithm 200 one hundred times with a code length of n_{bit}=32 on metapath2vec++ embeddings.

FIG. 4 shows four histograms generated using GloVe embeddings according to embodiments. Each histogram shows the relative number of collisions (e.g., duplicate rows in the binary compositional code matrix \hat{X}) that are encountered when running the encoding algorithm one hundred times on a set of GloVe embeddings. The GloVe embeddings used can be found in Pennington et al., “GloVe: Global Vectors for Word Representation,” Proceedings of the 2014 Conference on Empirical Methods in Natural Language Processing (EMNLP), pp. 1532-1543, 2014b. A first GloVe histogram 400 is formed by running the encoding algorithm 200 one hundred times with a code length of n_{bit}=20 on GloVe embeddings. A second GloVe histogram 410 is formed by running the encoding algorithm 200 one hundred times with a code length of n_{bit}=24 on GloVe embeddings. A third GloVe histogram 420 is formed by running the encoding algorithm 200 one hundred times with a code length of n_{bit}=28 on GloVe embeddings. A fourth GloVe histogram 430 is formed by running the encoding algorithm 200 one hundred times with a code length of n_{bit}=20 on GloVe embeddings.

In each of the histograms shown by FIGS. 3 and 4, the number of collisions is reduced by using the median as the threshold value t as opposed to a more commonly chosen option of 0. The choice of the median as the threshold value t helps to ensure that a unique code vector (e.g., a unique row of the binary compositional code matrix \hat{X}) is generated to represent each input node of the input matrix A, or its associated graph.

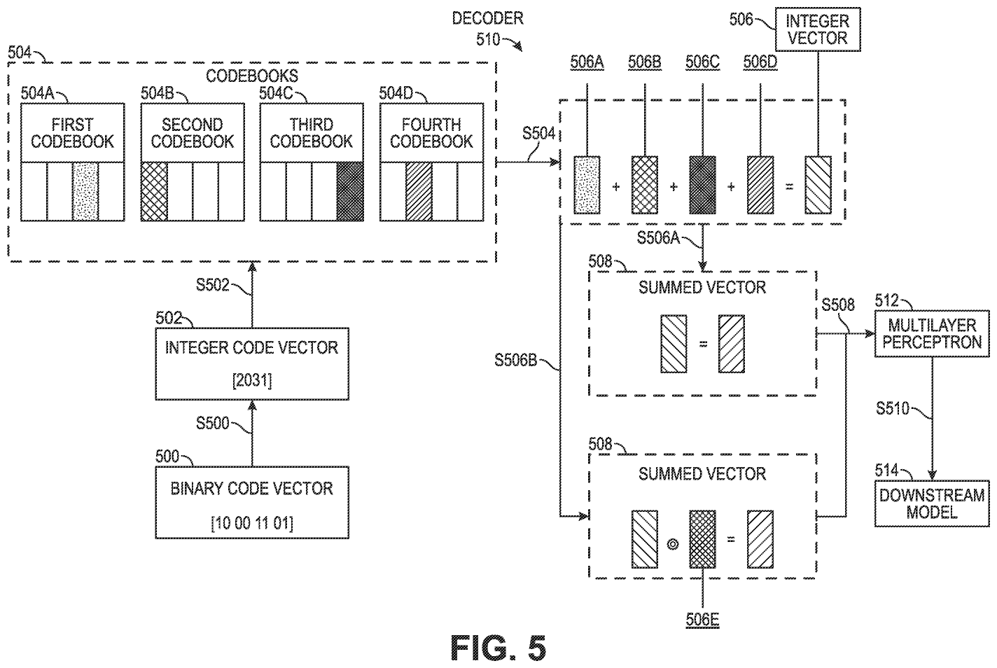

FIG. 5 shows a diagram illustrating a user of a decoder 510 according to embodiments. FIG. 5 illustrates a method comprising an encoding stage, where each input node's compositional code matrix is generated (e.g., a binary code vector 500 can be generated using the encoding algorithm 200 of FIG. 2 or any other suitable process), and a decoding stage, where the decoder is trained in an end-to-end fashion together with a downstream model 514. The binary code vector 500 can be converted into an integer code vector 502, which may then be fed into the decoder 510. The decoder 510 can output a summed vector 508 for the integer code vector 502, and a derivative of the summed vector 508, such as an embedding generated by a multilayer perceptron 512, can be fed into the downstream model 514.

The decoder 510 can include a plurality of codebooks 504 including a first codebook 504A, a second codebook 504B, a third codebook 504C, and a fourth codebook 504D. Although a specific number of codebooks is shown for purposes of illustration, there can be more codebooks in other embodiments. Each codebook is a [symbol] matrix, where c is the number of real number vectors in the codebook (e.g., the code cardinality value, such as the one used as input to the encoding algorithm 200) and d_{c} is the size of each real vector in the codebook. The plurality of codebooks 504 comprises a number of codebooks equal to the code length value m, where the code length value m is the total code length (e.g., the length of the code after being converted to integer from binary). In the example shown, there are four codebooks (e.g., m=4), each comprising 4 real vectors (e.g., c=4).

The decoder 510 can additionally include logic to perform the overlayed steps S500-S510. The input to the decoder 510 may be a binary compositional code matrix \hat{X}, such as those generated by the encoding algorithm 200 of FIG. 2. For ease of illustration, FIG. 5 shows a binary code vector 500, which may correspond to a single row of a binary compositional code matrix \hat{X}.

In step S500, the binary code vector 500 can be converted into an integer code vector 502. The conversion can be done directly, such as by a look-up table. In the example shown, the binary code vector 500 (e.g., [10, 00, 11, 01]) is converted to the integer code vector 502 (e.g., [2, 0, 3, 1]).

In step S502, the integer code vector 502 can be used to retrieve a set of real number vectors 506A-506D from the plurality of codebooks 504 based on corresponding indices. For example, the integer code vector 502 [2, 0, 3, 1] retrieves a first real number vector 506A corresponding to the index 2 from the first codebook 504A, a second real number vector 506B corresponding to the index 0 from the second codebook 504B, a third real number vector 506C corresponding to the index 3 from the third codebook 504C, and a fourth real number vector 506D corresponding to the index 1 from the fourth codebook 504D. The real number vectors of the codebooks 504 can be non-trainable random vectors, or trainable vectors. Both the trainable and non-trainable vectors can have elements that are initially randomly generated. Each codebook of the plurality of codebooks 504 can be said to be trainable if they comprise trainable vectors, or non-trainable if they comprise non-trainable random vectors. A trainable vector can be a vector that includes trainable parameters as elements (e.g., the elements can be modified as a part of training). A non-trainable vector can be a vector with randomly generated fixed elements. The use of trainable vectors increases the number of trainable parameters by mcd_{c} (e.g., number of codebooks*number of codes possible*length of real vectors), and has improved performance if the memory cost can be paid. Additionally, the memory cost of the trainable parameters of the trainable codebooks is independent of the number of nodes of an input matrix A (e.g., the input matrix A used to generate the binary compositional code matrix \hat{X}).

In step S504, the retrieved set of real number vectors 506A-506D can be summed to form an integer vector 506. The integer vector 506 can be the element-wise sum of the first real number vector 506A, the second real number vector 506B, the third real number vector 506C, and the fourth real number vector 506D.

In step S506A, if the plurality of codebooks 504 are trainable, the integer vector 506 can be a summed vector 508. For example, the summer vector 508 can be the element-wise sum of the first real number vector 506A, the second real number vector 506B, the third real number vector 506C, and the fourth real number vector 506D.

In step S506B, if the plurality of codebooks 504 are non-trainable, the element-wise product between the integer vector 506 and a trainable vector 506E can be computed to output a summed vector 508. The element-wise product between the two vectors can result in a rescaling of each dimension of the integer vector 506 such that the resultant summed vector 508 is unique for each input integer code vector 502. The rescaling method using the trainable vector 506E is described in the aforementioned Takase and Kobayashi, “All Word Embeddings from One Embedding.” The rescaling is not needed to form the summed vector 508 in step S506A because the trainable parameters of the trainable codebooks can instead be modified (as opposed to the trainable vector 506E) to ensure uniqueness.

In step S508, after the summed vector 508 is output by the trainable codebooks 504, or the summed vector 508 is output by the non-trainable codebooks 504, the summed vector 508 can be fed into a multilayer perceptron 512 to generate a derivative of the summed vector 508 corresponding to the integer code vector 502. In some embodiments, the multilayer perceptron 512 can comprise a ReLU function between linear layers, and can output an embedding corresponding to the input binary code vector 500. In some embodiments, the multilayer perceptron 512 can a receive an intermediate matrix as input. The multilayer perceptron 512 can process the intermediate matrix to form a processed intermediate matrix, which can be an embedding matrix (e.g., each row of the embedding matrix can be an embedding corresponding to vector similar integer code vector 502). The rows of the processed intermediate matrix can then be input into the downstream model 514.

In step S510, the derivative of the summed vector corresponding to the input binary code vector 500 can be fed into the downstream model 514. In some embodiments, the derivative of the summed vector can be an embedding.

The number of trainable parameters can be independent of the number of nodes both when using non-trainable codebooks and when using trainable codebooks. Given the number of neurons for the multilayer perceptron is set to dₘ, the number of layers is set to l≥2, and the dimension of the output embedding is set to d_{c}, when using non-trainable codebooks, there is a total of mcd_{c} non-trainable parameters (e.g., parameters that can be stored outside of GPU memory) and d_{c}+d_{c}dₘ+(l−2)dₘ²+dₘdₑ trainable parameters. When using trainable codebooks, there is a total of mcd_{c}+d_{c}dₘ+(l−2)dₘ²+dₘdₑ trainable parameters. The number of trainable parameters is independent of the number of nodes of the input.

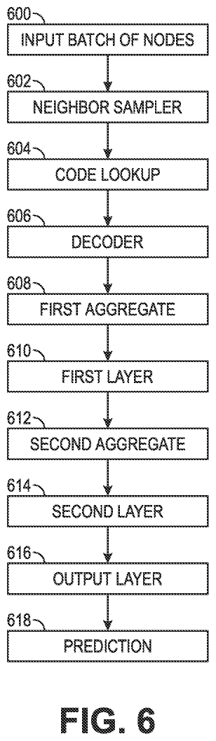

FIG. 6 shows a block diagram of a system integrated with an exemplary downstream machine learning model. An example of a downstream graph machine learning model is a GraphSAGE model. A forward pass of the training of decoder 510 integrated with a GraphSAGE model as the downstream model 514 is shown by FIG. 6.

At block 600, a batch of nodes of a graph are sampled. For example, a graph dataset of transaction data can plot a transaction in N-dimensional space. The transaction can have various features with high cardinality, such as transaction amount, timestamp, transaction identifier, user identifiers, etc. Several nodes of the transaction data can be sampled as nodes. Note that embodiments are not limited to transaction data, but can be applied to any other suitable type of data. For example, the data forming the graph can relate to recommendations (e.g., of content such as movies, recommendations of friends or pages of interest in social media networks, images similar to an input image), data (e.g., traffic data, road data, etc.) related to transportation for autonomous vehicles,

At block 602, a neighbor sampler can, for each sampled node, determine a set of first nearest neighbor nodes (e.g., most similar transactions). Additionally, because the shown GraphSAGE model has two layers, the neighbor sampler can, for each sampled node, determine a set of second nearest neighbor nodes (e.g., highly similar transactions).

At block 604, the binary compositional code matrix \hat{X} associated with the sampled node's first nearest neighbors and second nearest neighbors can be retrieved. For example, for each sampled node, the nodes of the set of first nearest neighbors and the nodes of the set of second nearest neighbors can be fed into the encoding algorithm 200 of FIG. 2 as an input matrix A.

At block 606, the binary compositional code matrix \hat{X} (or individually, the binary code vectors) can be decoded. For example, the binary compositional code matrix \hat{X}, or the rows of the binary compositional code matrix \hat{X} can be fed into the decoder 510 of FIG. 5. The multilayer perceptron 512 of the decoder 510 can output an embedding for each first nearest neighbor and second nearest neighbor of sampled nodes.

Blocks 608-616 illustrate a GraphSAGE model as shown in Hamilton et al., “Inductive Representation Learning on Large Graphs,” arXiv preprint arXiv:1706.02216, 2017.

At block 608, the second nearest neighbor embeddings for the first nearest neighbor embeddings of sampled nodes can be aggregated. For example, the aggregation can be performed using a mean or max function in the first aggregate layer. Given that a matrix Hᵢ contains the embeddings of nodes neighboring node i, the first aggregate layer computes [symbol] with Aggregate(Hᵢ).

At block 610, the first layer can, for each first nearest neighbor node of node i, the aggregate for the first nearest neighbor [symbol] and xᵢ (e.g., the embedding for node i) can be concatenated and processed. The process of the first layer can be represented as σ(W·Concatenate ( [symbol] , xᵢ)), where W is a weight associated with the first layer and σ(·) is some non-linearity like a ReLU.

At block 612, the first nearest neighbor embeddings for the sampled nodes can be aggregated, similarly, to block 608.

At block 614, the second layer can process the first nearest neighbor embeddings using some non-linearity, similarly, to block 610. However, the second layer does not concatenate the first nearest neighbor embeddings and the sampled node embeddings as they are not used in the GraphSAGE model.

At block 616, the learned representation is fed into an output (i.e., linear) layer. The output layer may generate a prediction 618 using the embeddings. The parameters of the model can be learned end-to-end using labeled training data.

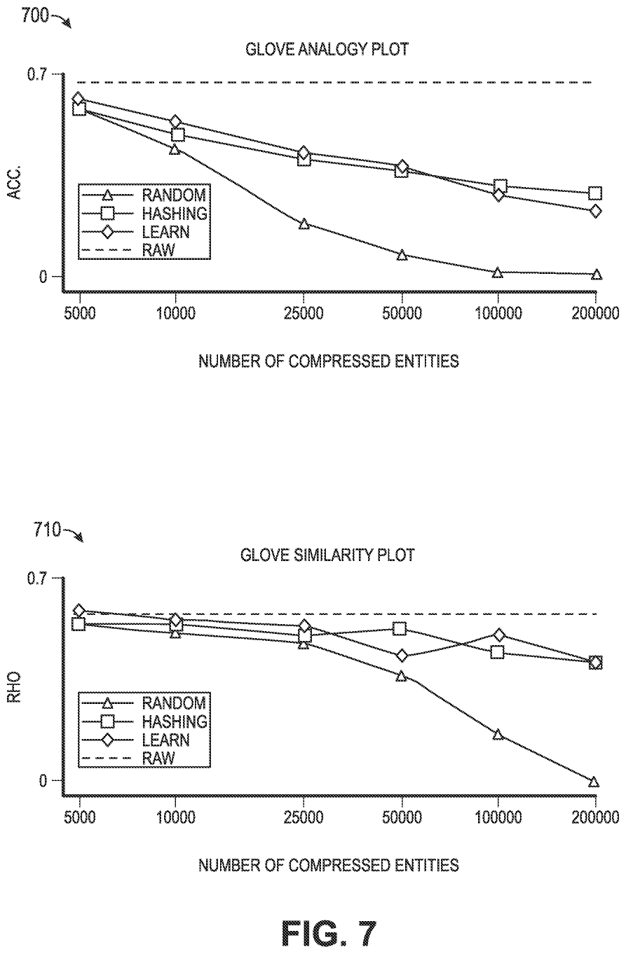

FIG. 7 shows four graphs of a performance metric vs number of compressed entities according to embodiments. The compression capability of the embodiments is tested by testing the quality of the embedding (e.g., how close the result retrieved using the embedding is to the raw data). The tested methods include random coding as proposed by the aforementioned Takase and Kobayashi, “All Word Embeddings from One Embedding,” learning-based coding as proposed by Shu, Raphael and Nakayama, Hideki, “Compressing Word Embeddings via Deep Compositional Code Learning,” arXiv preprint arXiv:1771.01068, 2017, and the method of embodiments. Three sets of pre-trained embeddings, including a 300 dimension GloVe word embedding set, a 128 dimension metapath2vec node embedding set, and a 128 dimension metapath2vec++ node embedding set are fed into the encoding algorithm 200 of FIG. 2. A GloVe analogy plot 700 is formed by running the encoding algorithm 200 on the GloVe word embedding set and testing for word analogy. The accuracy of the word analogy is used as the y-axis performance metric. A GloVe similarity plot 710 is formed by running the encoding algorithm 200 on the GloVe word embedding set and testing for word similarity. Spearman's rho is used as the y-axis performance metric. A metapath2vec plot 720 is formed by running the encoding algorithm 200 on the metapath2vec node embedding set with node clustering. A metapath2vec++ plot 730 is formed by running the encoding algorithm 200 on the metapath2vec++ node embedding set with node clustering.

When the number of compressed entities is low, the reconstructed embeddings from all of the tested compression methods perform similarly to the raw embeddings. However, as the number of compressed entities increases, the reconstructed embeddings' performance decreases, as the decoder model size does not grow with the number of compressed entities. In other words, the compression ratio increases as the number of compressed entities increases. The quality of the reconstructed embeddings from the random coding method performs significantly worse and drops sharply compared to other methods. The method by embodiments performs similarly to the learning-based coding method while using less parameters to learn the encoding functions.

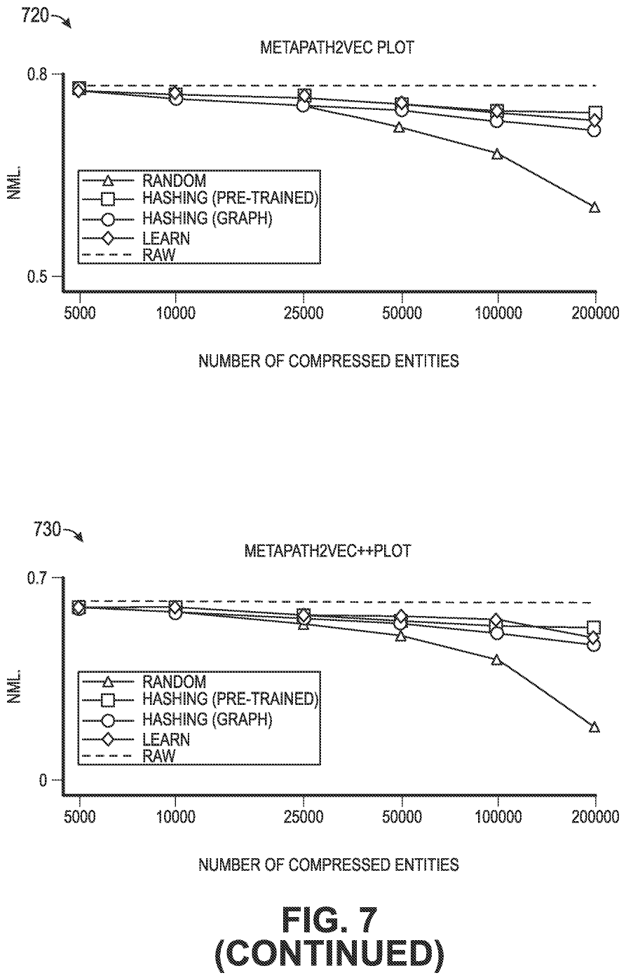

FIG. 8 shows a table 800 comparing performances of a baseline method, random coding method, and the method of embodiments. A node classification is performed, where the decoder 510 of FIG. 5 is trained together with a GraphSAGE model. The method of embodiments is compared with a random coding method and a raw embedding method. The raw embedding method explicitly learns the embeddings together with the GraphSAGE model with mean pooling and max pooling as the aggregator. The raw baseline method can be treated as the upper bound in terms of accuracy because the embeddings are not compressed. The methods are tested on ogbn-arxiv, ogbn-mag, and ogbn-products datasets from Open Graph Benchmark. The table 700 compares the classification accuracy of the three methods. The method of embodiments outperform the random coding method in all tested scenarios, which agrees with the results shown by the four graphs of FIG. 7. The method of embodiments is more effective for compressing larger sets of entities than the baseline random coding method.

Embodiments provide several advantages. Embodiments reduce the memory cost of storing embeddings, such that conventional GPUs can train embeddings on memory. Embodiments use a random projection based algorithm to generate a binary compositional code matrix that encodes an input matrix formed from nodes of a graph, where each row of the binary compositional code matrix corresponds to a node of the graph. Embodiments then use a decoder to decode each row of the binary compositional code matrix into a summed vector. The summed vector can then be fed into a multilayer perceptron to generate an embedding for the associated node of the graph. The embedding may then be fed into any downstream model. The binary compositional code matrix provides for a significant reduction in memory to store the embeddings of input matrices.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
generating, by a server computer, a binary compositional code matrix from an input matrix derived from input data used to make a prediction;
converting, by the server computer, the binary compositional code matrix into an integer code matrix;
inputting, by the server computer, each row of the integer code matrix into a decoder comprising plurality of codebooks to output a summed vector for each row; and
inputting, by the server computer, derivatives of the summed vectors into a downstream machine learning model to output a prediction.

2. The method of claim 1, wherein decoder comprises one or more trainable codebooks, wherein each row of the integer code matrix is used to retrieve real number vectors from the decoder, and wherein the summed vector is formed by summing the real number vectors.

3. The method of claim 1, wherein decoder comprises one or more non-trainable codebooks, wherein each row of the integer code matrix is used to retrieve real number vectors from the decoder, and wherein the summed vector is formed by computing an element-wise product of a sum of the real number vectors and a trainable vector.

4. The method of claim 1, wherein the generating the binary compositional code matrix comprises:
generating an initial binary compositional code matrix, wherein each element of the initial binary compositional code matrix is set to logical false;
for each column of the initial binary compositional code matrix:
randomly generating a first vector;
initializing a second vector;
for each element of the second vector, computing a product between the first vector and the input matrix, wherein a result of the product is stored by the second vector;
computing a threshold value using the second vector; and
for each element of the second vector, comparing the element of the second vector to the threshold value, and if the element is larger than the threshold value, setting a corresponding element in the initial binary compositional code matrix to logical true to generate the binary compositional code matrix.

5. The method of claim 1, wherein the derivatives of the summed vectors are embeddings, and wherein the method further comprises:
inputting, by the server computer, each summed vector into a multilayer perceptron that outputs an embedding corresponding to the row of the integer code matrix to generate the embeddings.

6. The method of claim 1, further comprising:
obtaining, by the server computer, a code cardinality value, wherein each of the plurality of codebooks comprises a number of real number vectors equal to the code cardinality value.

7. The method of claim 1, further comprising:
obtaining, by the server computer, a code length value, wherein a number of codebooks in the plurality of codebooks is equal to the code length value.

8. The method of claim 1, wherein the input matrix is derived from graph data of a graph, which is derived from the input data.

9. The method of claim 8, wherein the input matrix is formed by at least sampling a batch of nodes of the graph.

10. The method of claim 9, wherein the input matrix includes data relating to a set of first nearest neighbors and a set of second nearest neighbors of each node in the batch of nodes of the graph.

11. The method of claim 1, wherein the downstream machine learning model is a GraphSAGE model.

12. The method of claim 1, wherein the input data comprises traffic data, interaction data, or word data.

13. The method of claim 1, further comprising:
receiving, by the server computer, an output prediction from the downstream machine learning model.

14. The method of claim 1, wherein the input matrix is received from a data computer, and the prediction is provided to the data computer, which causes a machine to actuate in response to receiving the prediction.

15. A server computer comprising:
a processor; and
a non-transitory computer readable medium comprising instructions, executable by the processor, for implementing operations including:
generating a binary compositional code matrix from an input matrix derived from input data used to make a prediction;
converting the binary compositional code matrix into an integer code matrix;
inputting each row of the integer code matrix into a decoder comprising plurality of codebooks to output a summed vector for each row; and
inputting derivatives of the summed vectors into a downstream machine learning model to output a prediction.

16. The server computer of claim 15, wherein decoder comprises one or more trainable codebooks, wherein each row of the integer code matrix is used to retrieve real number vectors from the decoder, and wherein the summed vector is formed by summing the real number vectors.

17. The server computer of claim 15, wherein decoder comprises one or more non-trainable codebooks, wherein each row of the integer code matrix is used to retrieve real number vectors from the decoder, and wherein the summed vector is formed by computing an element-wise product of a sum of the real number vectors and a trainable vector.

18. The server computer of claim 15, wherein the generating the binary compositional code matrix comprises using a random project-based method to generate the binary compositional code matrix.

19. The server computer of claim 15, wherein the derivatives of the summed vectors are embeddings, and wherein the operations further comprise:
inputting, by the server computer, each summed vector into a multilayer perceptron that outputs an embedding corresponding to the row of the integer code matrix to generate the embeddings.

20. The server computer of claim 15, wherein the input matrix is derived from graph data of a graph, which is derived from the input data.
